(19) United States
(12) Patent Application Publication
(10) Pub. No.: US 2026/0104396 A1
(43) Pub. Date: Apr. 16, 2026

(54) ANIMAL ULTRASONIC MECHANICAL ARM AUTOMATIC CALIBRATION METHOD AND SYSTEM

(71) Applicant: XIYUAN HOSPITAL OF CHINA ACADEMY OF CHINESE MEDICAL SCIENCES, Beijing (CN)

(72) Inventors: Hao Guo, Beijing (CN); Wenwen Yang, Beijing (CN); Xiaoshan Cui, Beijing (CN)

(21) Appl. No.: 19/279,481

(22) Filed: Jul. 24, 2025

(30) Foreign Application Priority Data
Oct. 16, 2024 (CN) 202411443381.0

(51) Int. Cl. G01N 29/30; G01N 29/06; G01N 29/22; G01N 29/265

(52) U.S. Cl. CPC G01N 29/30; G01N 29/0654; G01N 29/223; G01N 29/265; G01N 2291/02466; G01N 2291/02483

(57) ABSTRACT

An animal ultrasonic mechanical arm automatic calibration method and system, including following steps: S1, constructing a target recognition model; S2, obtaining an initial ultrasound image and an initial white light image, determining a type of a target organ, and marking the determined target organ on the initial white light image; S3, obtaining an initial movement amount of the mechanical arm assembly; S4, the mechanical arm assembly moves a distance of the initial movement amount in a direction close to the detected animal; S5, using the steps S2-S3 to obtain a re-movement amount of the mechanical arm assembly when the mechanical arm assembly is located at the first movement position, and determining whether the mechanical arm assembly moves in the X direction, Y direction, and Z direction, when the mechanical arm assembly does not need to move, completing the calibration of the mechanical arm assembly, otherwise, iterating steps S4-S5.

### CROSS-REFERENCE TO RELATED APPLICATIONS

This application claims the priority and benefit of Chinese patent application No. 202411443381.0, filed on Oct. 16, 2024. The entirety of Chinese patent application No. 202411443381.0 is hereby incorporated by reference herein and made a part of this specification.

### TECHNICAL FIELD

The present disclosure relates to the technical field of mechanical arms, and in particular to an animal ultrasonic mechanical arm automatic calibration method and system.

### BACKGROUND ART

The animal ultrasound imaging system is an ultrasound imaging equipment specially used in the field of experimental animals. Its function and principle are exactly the same as those of clinical ultrasound equipment. The animal ultrasound equipment requires a set of operation tables and probes to fix the animals. The existing animal ultrasound equipment mainly includes two parts. One part is the animal fixing table, which is divided into two specifications for rats and mice. The rats or mice need to be fixed on the table surface. There are four copper electrodes on the table surface. The limbs of the rats or mice need to be connected to the four copper electrodes to measure the temperature and electrocardiogram of the rats or mice. The other part is the ultrasound probe fixing frame and the probe. The ultrasound probe fixing frame is configured to clamp the probe and also to drive the probe to move horizontally and vertically.

The probes in existing animal ultrasound equipment are mostly adjusted and moved to the target organ position of the animal to be detected through manually operating the ultrasound probe fixing frame. Since the quality of ultrasound imaging will directly affect the accuracy of the test results, the technical requirements for the operator are relatively high. The probe needs to be accurately moved to the target organ position of the animal to be detected. However, due to the influence of manual operation, the positioning of the probe may not be accurate enough, which will affect the quality of ultrasound imaging.

Therefore, there is a need to provide an animal ultrasonic mechanical arm automatic calibration method and system, which can improve the accuracy of probe positioning and ensure the quality of ultrasound imaging compared to the existing technology.

### SUMMARY

The present disclosure solves the technical problems in the existing technology and provides an animal ultrasonic mechanical arm automatic calibration method and system.

In order to achieve the above-mentioned purpose of the disclosure,

An animal ultrasonic mechanical arm automatic calibration method is provided, which includes the following steps:
S1, building a target recognition model;
S2, placing a mechanical arm assembly in an initial state, fixing an animal to be detected on a fixed table, starting an ultrasound probe and a micro camera, taking a picture of the animal to be detected, obtaining an initial ultrasound image and an initial white light image, determining a type of a target organ, and marking the determined target organ on the initial white light image;
S3, inputting the initial ultrasound image, the marked initial white light image, and the determined target organ into the target recognition model constructed in the step S1 to obtain an output result, and obtaining an initial movement amount of the mechanical arm assembly according to the output result, the initial movement amount includes an initial X-direction movement amount, an initial Y-direction movement amount, and an initial Z-direction movement amount;
S4, controlling the mechanical arm assembly through a controller to move the mechanical arm assembly in an X direction of a world coordinate by the initial X-direction movement amount, in a Y direction of the world coordinate by the initial Y-direction movement amount, and in a Z direction of the world coordinate by the initial Z-direction movement amount, in a direction close to the detected animal, and a position of the mechanical arm assembly after movement is recorded as a first movement position;
S5, using the steps S2-S3 to obtain a re-movement amount of the mechanical arm assembly when the mechanical arm assembly is located at the first movement position, the re-movement amount includes an X-direction re-movement amount, a Y-direction re-movement amount and a Z-direction re-movement amount, setting an X-direction movement threshold, a Y-direction movement threshold and a Z-direction movement threshold of the mechanical arm assembly, determining the X-direction re-movement amount, the Y-direction re-movement amount and the Z-direction re-movement amount with the X-direction movement threshold, the Y-direction movement threshold and the Z-direction movement threshold respectively, whether the mechanical arm assembly moves in the X direction, the Y direction and the Z direction, after the determination, when the mechanical arm assembly does not need to move in the X direction, the Y direction and the Z direction, completing the calibration of the mechanical arm assembly, otherwise, iterating the steps S4-S5.

Further, S3 specifically includes the following steps:
S31, inputting the initial ultrasound image, the marked initial white light image, and the determined target organ into the target recognition model constructed in the step S1, and obtaining the output result, wherein the output result includes a first initial pixel coordinate and a first initial confidence of the determined target organ in the initial ultrasound image, and a second initial pixel coordinate and a second initial confidence of the determined target organ in the marked initial white light image;
S32, converting the first initial pixel coordinate and the second initial pixel coordinate obtained in the step S31 into a first initial world coordinate and a second initial world coordinate;
S33, calculating distances between the ultrasound probe and the micro camera in the X direction, the Y direction, and the Z direction in the world coordinate;
S34, calculating an auxiliary world coordinate of the second initial world coordinate according to the distance between the ultrasound probe and the micro camera in the X direction, the Y direction, and the Z direction in the world coordinate;
S35, calculating a total initial world coordinate of the determined target organ according to the auxiliary world coordinate and the first initial world coordinate;
S36. calculating the initial X-direction movement amount, the initial Y-direction movement, and the initial Z-direction movement of the mechanical arm assembly according to the total initial world coordinate.

Furthermore, the total initial world coordinate in the step S35 is calculated by following formulas:

$${X}_{z} = {ω}_{1} \times {X}_{cs 1} + {ω}_{2} \times {X}_{cs}^{′} ;$$

$${Y}_{z} = {ω}_{1} \times {Y}_{cs 1} + {ω}_{2} \times {Y}_{cs}^{′} ;$$

$${Z}_{z} = {ω}_{1} \times {Z}_{cs 1} + {ω}_{2} \times {Z}_{cs}^{′} ;$$

in the above formulas, X_{z} indicates a coordinate value of the total initial world coordinate in the X direction, Y_{z} indicates a coordinate value of the total initial world coordinate in the Y direction, Z_{z} indicates a coordinate value of the total initial world coordinate in the Z direction; co indicates a first weight value, ω₂ indicates a second weight value; X_{cs1} indicates a coordinate value of the first initial world coordinate in the X direction, Y_{cs1} indicates a coordinate value of the first initial world coordinate in the Y direction, Z_{cs1} indicates a coordinate value of the first initial world coordinate in the Z direction; X_{cs}′ indicates a coordinate value of the auxiliary world coordinate in the X direction, Y_{cs}′ indicates a coordinate value of the auxiliary world coordinate in the Y direction, Z_{cs}′ indicates a coordinate value in the Z direction of the auxiliary world coordinate.

Furthermore, the first weight value and the second weight value are calculated according to following formulas:

$${ω}_{1} = \frac{{α}_{1}}{{α}_{1} + {α}_{2}} ;$$

$${ω}_{2} = \frac{{α}_{2}}{{α}_{1} + {α}_{2}} ;$$

in the above formulas, α₁ indicates the first initial confidence, α₂ indicates the second initial confidence.

Furthermore, the initial X-direction movement amount, the initial Y-direction movement amount and the initial Z-direction movement amount in the step S36 are calculated according to following formulas:

$$Δ X = \vert {X}_{z} - {X}_{w 1} \vert ;$$

$$Δ Y = \vert {Y}_{z} - {Y}_{w 1} \vert ;$$

$$Δ Z = \vert {Z}_{z} - {Z}_{w 1} \vert ;$$

in the above formulas, ΔX indicates the initial X-direction movement amount, ΔY indicates the initial Y-direction movement amount, ΔZ indicates the initial Z-direction movement amount of the mechanical arm assembly; X_{w1} indicates a coordinate value of the initial world coordinate of the ultrasound probe in the X direction, Y_{w1} indicates a coordinate value of the initial world coordinate of the ultrasound probe in the Y direction, Z_{w1} indicates a coordinate value of the initial world coordinate of the ultrasound probe in the Z direction.

Furthermore, the step S33 is: when the mechanical arm assembly is configured at a initial position, the initial world coordinate of the ultrasound probe is (X_{w1}, Y_{w1}, Z_{w1}), the initial world coordinate of the micro camera is (X_{w2}, Y_{w2}, Z_{w2}), the distance between the ultrasound probe and the micro camera in the X direction, the Y direction, and the Z direction in the world coordinate is calculated by following formulas:

$${X}_{Δ} = {X}_{w 1} - {X}_{w 2} ;$$

$${Y}_{Δ} = {Y}_{w 1} - {Y}_{w 2} ;$$

$${Z}_{Δ} = {Z}_{w 1} - {Z}_{w 2} ;$$

in the above formulas, X_{Δ} indicates the distance between the ultrasound probe and the micro camera in the X direction in the world coordinate, Y_{Δ} indicates the distance between the ultrasound probe and the micro camera in the Y direction in the world coordinate, Z_{Δ} indicates the distance between the ultrasound probe and the micro camera in the Z direction in the world coordinate; X_{w2} indicates a coordinate value of the initial world coordinate in the X direction of the micro camera, Y_{w2} indicates a coordinate value of the initial world coordinate in the Y direction of the micro camera, Z_{w2} indicates a coordinate value of the initial world coordinate in the Z direction of the micro camera.

Furthermore, the auxiliary world coordinate in the step S34 is specifically calculated by following formulas:

$${X}_{cs}^{′} = {X}_{cs 2} + {X}_{Δ} ;$$

$${Y}_{cs}^{′} = {Y}_{cs 2} + {Y}_{Δ} ;$$

$${Z}_{cs}^{′} = {Z}_{cs 2} + {Z}_{Δ} ;$$

in the above formulas, X_{cs2} indicates the coordinate value of the second initial world coordinate in the X direction, Y_{cs2} indicates the coordinate value of the second initial world coordinate in the Y-direction, Z_{cs2} indicates the coordinate value of the second initial world coordinate in the Z direction.

Furthermore, determining whether the mechanical arm assembly moves in the X direction, the Y direction, and the Z direction in the step S5 is:
comparing the X-direction re-movement amount with the X-direction movement threshold of the mechanical arm assembly, when the X-direction re-movement amount is greater than the X-direction movement threshold of the mechanical arm assembly, the controller controls the mechanical arm assembly to move in the X-direction by the X-direction re-movement amount; when the X-direction re-movement amount is less than or equal to the X-direction movement threshold of the mechanical arm assembly, the controller does not control the mechanical arm assembly to move in the X-direction;
comparing the Y-direction re-movement amount with the Y-direction movement threshold of the mechanical arm assembly, when the Y-direction re-movement amount is greater than the Y-direction movement threshold of the mechanical arm assembly, the controller controls the mechanical arm assembly to move in the Y-direction by the Y-direction re-movement amount; when the Y-direction re-movement amount is less than or equal to the Y-direction movement threshold of the mechanical arm assembly, the controller does not control the mechanical arm assembly to move in the Y-direction;
comparing the Z-direction re-movement amount with the Z-direction movement threshold of the mechanical arm assembly, when the Z-direction re-movement amount is greater than the Z-direction movement threshold of the mechanical arm assembly, the controller controls the mechanical arm assembly to move in the Z-direction by the Z-direction re-movement amount; when the Z-direction re-movement amount is less than or equal to the Z-direction movement threshold of the mechanical arm assembly, the controller does not control the mechanical arm assembly to move in the Z-direction.

Further, S1 specifically includes the following steps:
S11, acquiring a plurality of historical ultrasound images and a plurality of historical white light images, each of the historical ultrasound images and each of the historical white light images includes the animal to be detected;
S12, marking a plurality of the target organs on the animal to be detected in each historical white light image;
S13, training and obtaining the target recognition model using a YOLOv8 algorithm based on the plurality of the historical ultrasound images obtained in the step S11 and the plurality of the historical white light images processed in the step S12.

The disclosure also related to an animal ultrasonic mechanical arm automatic calibration system, executing an animal ultrasonic mechanical arm automatic calibration method, including a base, the mechanical arm assembly, the fixed table, a control device, the ultrasound probe and the micro camera, the mechanical arm assembly and the fixed table are connected to the base, an end of the mechanical arm assembly away from the base is connected to the ultrasound probe and the micro camera, relative positions of the ultrasound probe and the micro camera are fixed, the control device is electrically connected to the mechanical arm assembly, the ultrasound probe and the micro camera respectively, the ultrasound probe is configured to take the ultrasonic images containing the animal to be detected, and the micro camera is configured to take the white light images containing the animal to be detected.

Compared with the existing technology, the beneficial effects of the disclosure are that:

According to the present disclosure, the output results of the target recognition algorithm are sorted and calculated by inputting the ultrasonic image and the white light image into the target recognition algorithm at the same time to obtain the movement amount that the mechanical arm assembly needs to move. According to the ultrasonic image and the white light image, the joint calibration can effectively improve the accuracy of the calibration and positioning of the mechanical arm assembly. In addition, after each movement of the mechanical arm assembly, the movement amount should be calculated and the movement threshold should be set. Through the determination method, it is determined whether the mechanical arm assembly needs to move again, which can further improve the accuracy of calibration and positioning of the mechanical arm assembly, so that the quality of ultrasonic imaging is ensured. It can also be used in teaching.

### BRIEF DESCRIPTION OF THE DRAWINGS

FIG. 1 is a flow chart of the method of the present disclosure.

FIG. 2 is a schematic diagram of the system of the present disclosure.

### DETAILED DESCRIPTION

The technical scheme of the present disclosure will be clearly described below with reference to the accompanying drawings. Obviously, the described embodiments are not all embodiments of the present disclosure, and all other embodiments obtained by those of ordinary skill in the art without making any creative work shall fall within the scope of protection of the present disclosure. It should be noted that the orientations or positional relationships indicated by the terms “center”, “upper”, “lower”, “left”, “right”, “vertical” and “horizontal” etc. are based on the orientations or positional relationships shown in the accompanying drawings, and are only for the convenience of describing the present disclosure and simplifying the description, rather than indicating or implying that the device or element referred to must have a specific orientation, be constructed and operated in a specific orientation, and therefore cannot be understood as a limitation on the present disclosure.

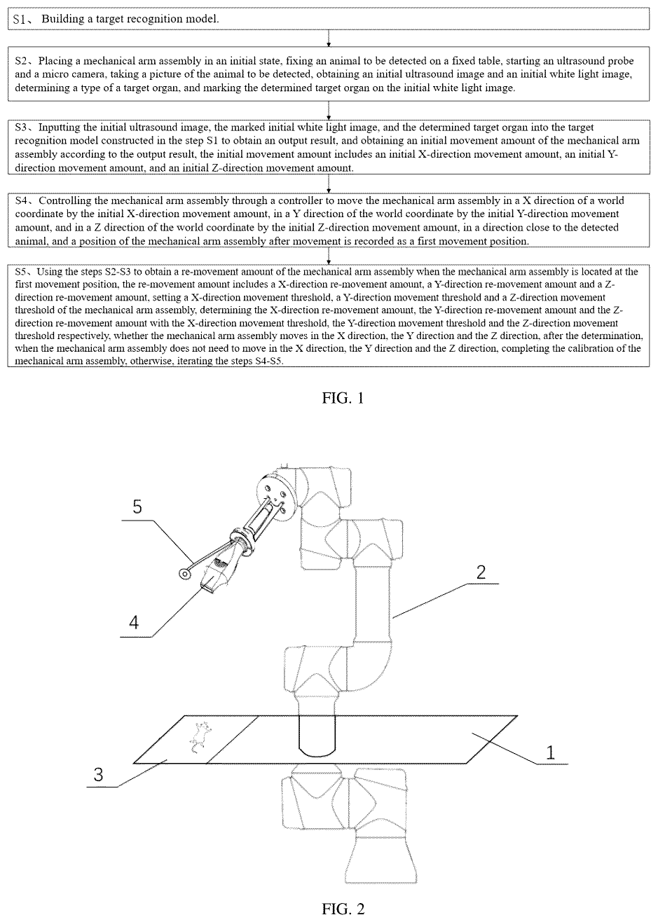

As shown in FIG. 1, the disclosure provides an animal ultrasonic mechanical arm automatic calibration method including following steps:
S1, building a target recognition model, which specifically includes the following steps:
S11, acquiring a plurality of historical ultrasound images and a plurality of historical white light images, each of the historical ultrasound images and each of the historical white light images include the animal to be detected.
S12, marking the target organ on the animal to be detected in each historical white light image, using a rectangular frame to mark the target organ on the animal to be detected according to the position of the target organ in the body of the animal to be detected and the normal proportion of the target organ in the animal to be detected, the target organ includes but is not limited to the heart.
S13, training and obtaining the target recognition model using a YOLOv8 algorithm based on the plurality of the historical ultrasound images obtained in the step S11 and the plurality of the historical white light images processed in the step S12, so that when the real-time ultrasound image, the real-time white light image and the target organ are subsequently input into the trained target recognition model, the pixel coordinate and confidence of the target organ in the ultrasound image and the white light image can be respectively identified.
S2, placing the mechanical arm assembly 2 in the initial state, fixing the animal to be detected on the fixed table 3, starting the ultrasound probe 4 and the micro camera 5, taking a picture of the animal to be detected, obtaining an initial ultrasound image and an initial white light image, determining the type of the target organ (the type of the target organ determined in this step is one of all the target organ types trained in step S1), and using the rectangular frame to mark the determined target organ on the initial white light image to obtain the marked initial white light image.
S3, inputting the initial ultrasound image, the marked initial white light image, and the determined target organ into the target recognition model constructed in the step S1 to obtain an output result of the target recognition model, and obtaining an initial movement amount of the mechanical arm assembly 2 according to the output result of the target recognition model, the initial movement amount includes an initial X-direction movement amount, an initial Y-direction movement amount, and an initial Z-direction movement amount. S3 specifically includes the following steps:
S31, inputting the initial ultrasound image, the marked initial white light image, and the determined target organ into the target recognition model constructed in the step S1, and obtaining the output result, wherein the output result includes a first initial pixel coordinate and a first initial confidence of the determined target organ in the initial ultrasound image, and a second initial pixel coordinate and a second initial confidence of the determined target organ in the marked initial white light image.
S32, converting the first initial pixel coordinate and the second initial pixel coordinate obtained in the step S31 into the first initial world coordinate and the second initial world coordinate, specifically converting the pixel coordinate into the world coordinate by using the YOLOv8 algorithm, the specific conversion process can refer to the following procedures:

| import numpy as np | | | |
|---|---|---|---|
| # Assumed micro camera internal parameters | | | |
| fx = 1000 | # focal length | | |
| cx = 320 | # principal point x coordinate | | |
| fy = 1000 | # focal length (usually the same as fx) | | |
| cy = 240 | # principal point y coordinate | | |
| # Pixel coordinate of a single bounding box [x, y, width, height]; | | | |
| bbox_pixel = [200, 150, 100, 80] | | | |
| # Converting pixel coordinate to coordinate relative to the center of the image | | | |
| bbox_relative = np.array(bbox_pixel) | | | |
| bbox_relative[0] −= cx | | | |
| bbox_relative[1] −= cy | | | |
| # Assuming that the width and height of the object are in meters | | | |
| object_width_meters = 0.1 # Example units | | | |
| object_height_meters = 0.1 # Example units | | | |
| # Converting to the world coordinate | | | |
| bbox_world = bbox_relative * np.array([fx, fy, fx, fy]) | | | |
| bbox_world | /= | np.array([object_width_meters, | object_height_meters, |

object_width_meters, object_height_meters])

# Output the world coordinate
print(“World Coordinates:”, bbox_world)

S33, calculating the distance between the ultrasound probe 4 and the micro camera 5 in the X direction, the Y direction and the Z direction in the world coordinate, when the mechanical arm assembly 2 is configured at a initial position, the initial world coordinate of the ultrasound probe 4 is (X_{w1}, Y_{w1}, Z_{w1}), the initial world coordinate of the micro camera 5 is (X_{w2}, Y_{w2}, Z_{w2}), the distance between the ultrasound probe 4 and the micro camera 5 in the X direction, the Y direction, and the Z direction in the world coordinate is calculated by following formulas:

$${X}_{Δ} = {X}_{w 1} - {X}_{w 2} ;$$

$${Y}_{Δ} = {Y}_{w 1} - {Y}_{w 2} ;$$

$${Z}_{Δ} = {Z}_{w 1} - {Z}_{w 2} ;$$

in the above formulas, X_{Δ} indicates the distance between the ultrasound probe 4 and the micro camera 5 in the X direction in the world coordinate, Y_{Δ} indicates the distance between the ultrasound probe 4 and the micro camera 5 in the Y direction in the world coordinate, Z_{Δ} indicates the distance between the ultrasound probe 4 and the micro camera 5 in the Z direction in the world coordinate; X_{w1} indicates the coordinate value of the initial world coordinate in the X direction of the ultrasound probe 4, Y_{w1} indicates the coordinate value of the initial world coordinate in the Y direction of the ultrasound probe 4, Z_{w1} indicates the coordinate value of the initial world coordinate in the Z direction of the ultrasound probe 4 X_{w2} indicates the coordinate value of the initial world coordinate in the X direction of the micro camera 5, Y_{w2} indicates the coordinate value of the initial world coordinate in the Y direction of the micro camera 5, Z_{w2} indicates the coordinate value of the initial world coordinate in the Z direction of the micro camera 5.
S34, calculating the auxiliary world coordinate of the second initial world coordinate, recorded as (X_{cs}′, Y_{cs}′, Z_{cs}′), it is specifically calculated by the following formulas:

$${X}_{cs}^{′} = {X}_{cs 2} + {X}_{Δ} ;$$

$${Y}_{cs}^{′} = {Y}_{cs 2} + {Y}_{Δ} ;$$

$${Z}_{cs}^{′} = {Z}_{cs 2} + {Z}_{Δ} ;$$

in the above formulas, X_{cs}′ indicates the coordinate value of the auxiliary world coordinate in the X direction, Y_{cs}′ indicates the coordinate value of the auxiliary world coordinate in the Y direction, Z_{cs}′ indicates the coordinate value of the auxiliary world coordinate in the Z direction, X_{cs2} indicates the coordinate value of the second initial world coordinate in the X direction, Y_{cs2} indicates the coordinate value of the second initial world coordinate in the Y direction, Z_{cs2} indicates the coordinate value of the second initial world coordinate in the Z direction.
S35, calculating the total initial world coordinate of the determined target organ, recorded as (X_{z}, Y_{z}, Z_{z}), which is specifically calculated by the following formulas:

$${X}_{z} = {ω}_{1} \times {X}_{cs 1} + {ω}_{2} \times {X}_{cs}^{′} ;$$

$${Y}_{z} = {ω}_{1} \times {Y}_{cs 1} + {ω}_{2} \times {Y}_{cs}^{′} ;$$

$${Z}_{z} = {ω}_{1} \times {Z}_{cs 1} + {ω}_{2} \times {Z}_{cs}^{′} ;$$

in the above formulas, X_{z} indicates a coordinate value of the total initial world coordinate in the X direction, Y_{z} indicates a coordinate value of the total initial world coordinate in the Y direction, Z_{z} indicates a coordinate value of the total initial world coordinate in the Z direction; ω₁ indicates a first weight value, ω₂ indicates a second weight value; X_{cs1} indicates a coordinate value of the first initial world coordinate in the X direction, Y_{cs1} indicates a coordinate value of the first initial world coordinate in the Y direction, Z_{cs1} indicates a coordinate value of the first initial world coordinate in the Z direction.

The first weight value and the second weight value are calculated according to following formulas:

$${ω}_{1} = \frac{{α}_{1}}{{α}_{1} + {α}_{2}} ;$$

$${ω}_{2} = \frac{{α}_{2}}{{α}_{1} + {α}_{2}} ;$$

in the above formulas, α₁ indicates the first initial confidence, α₂ indicates the second initial confidence.
S36, calculating the initial movement amount of the mechanical arm assembly 2, i.e. the initial X-direction movement amount, the initial Y-direction movement, and the initial Z-direction movement of the mechanical arm assembly 2:

$$Δ X = \vert {X}_{z} - {X}_{w 1} \vert ;$$

$$Δ Y = \vert {Y}_{z} - {Y}_{w 1} \vert ;$$

$$Δ Z = \vert {Z}_{z} - {Z}_{w 1} \vert ;$$

in the above formulas, ΔX indicates the initial X-direction movement, ΔY indicates the initial Y-direction movement, ΔZ indicates the initial Z-direction movement of the mechanical arm assembly 2.
S4, controlling the mechanical arm assembly 2 through the controller to move the distance of the initial X-direction movement amount in the X direction, the distance of the initial Y-direction movement amount in the Y direction, and the distance of the initial Z-direction movement amount in the Z direction in the direction close to the animal to be detected, and the position of the mechanical arm assembly 2 after movement is recorded as a first movement position, acquiring the world coordinate of the ultrasound probe 4 at the first movement position.
S5, using the steps S2-S3, replacing the initial world coordinate of the ultrasound probe 4 in step S36 with the obtained world coordinate of the ultrasound probe 4 at the first movement position, and calculating and obtaining the re-movement amount of the mechanical arm assembly 2, the re-movement amount includes the X-direction re-movement amount, the Y-direction re-movement amount, and the Z-direction re-movement amount, setting the X-direction movement threshold, the Y-direction movement threshold and the Z-direction movement threshold, which are respectively recorded as XR, YR, ZR, determining whether the mechanical arm assembly 2 moves in the X direction, the Y direction, and the Z direction, after the determination, when the mechanical arm assembly 2 does not need to move in the X direction, the Y direction, and the Z direction, the mechanical arm assembly 2 completes the calibration and performs ultrasonic detection on the animal to be detected, otherwise, iterating steps S4-S5, until the mechanical arm assembly 2 does not need to move in the X direction, the Y direction, and the Z direction.

The determination method is:
comparing the X-direction re-movement amount with the X-direction movement threshold of the mechanical arm assembly 2, when the X-direction re-movement amount is greater than the X-direction movement threshold of the mechanical arm assembly 2, the controller controls the mechanical arm assembly 2 to move in the X-direction by the X-direction re-movement amount; when the X-direction re-movement amount is less than or equal to the X-direction movement threshold of the mechanical arm assembly 2, the controller does not control the mechanical arm assembly 2 to move in the X-direction.
comparing the Y-direction re-movement amount with the Y-direction movement threshold of the mechanical arm assembly 2, when the Y-direction re-movement amount is greater than the Y-direction movement threshold of the mechanical arm assembly 2, the controller controls the mechanical arm assembly 2 to move in the Y-direction by the Y-direction re-movement amount; when the Y-direction re-movement amount is less than or equal to the Y-direction movement threshold of the mechanical arm assembly 2, the controller does not control the mechanical arm assembly 2 to move in the Y-direction.
comparing the Z-direction re-movement amount with the Z-direction movement threshold of the mechanical arm assembly 2, when the Z-direction re-movement amount is greater than the Z-direction movement threshold of the mechanical arm assembly 2, the controller controls the mechanical arm assembly 2 to move in the Z-direction by the Z-direction re-movement amount; when the Z-direction re-movement amount is less than or equal to the Z-direction movement threshold of the mechanical arm assembly 2, the controller does not control the mechanical arm assembly 2 to move in the Z-direction.

As shown in FIG. 2, the disclosure also provides an animal ultrasonic mechanical arm automatic calibration system including a base 1, the mechanical arm assembly 2, the fixed table 3, a control device, the ultrasound probe 4 and the micro camera 5, the mechanical arm assembly 2 and the fixed table 3 are connected to the base 1, an end of the mechanical arm assembly 2 away from the base 1 is connected to the ultrasound probe 4 and the micro camera 5, relative positions of the ultrasound probe 4 and the micro camera 5 are fixed, the control device is electrically connected to the mechanical arm assembly 2, the ultrasound probe 4 and the micro camera 5 respectively, the ultrasound probe 4 is configured to take the ultrasonic images containing the animal to be detected, and the micro camera 5 is configured to take the white light images containing the animal to be detected. The mechanical arm assembly 2 adopts a six-axis mechanical arm.

The control device includes a controller, an image acquisition module, and a calculation module. The image acquisition module is configured to acquire an ultrasonic image taken by the ultrasound probe 4 and a white light image taken by the micro camera 5. The calculation module processes the ultrasonic image and the white light image acquired by the image acquisition module to obtain the X-coordinate, the Y-coordinate, and the Z-coordinate required for the movement of the mechanical arm assembly 2. The calculation module inputs the calculated X-coordinate, Y-coordinate, and Z-coordinate required for the movement of the mechanical arm assembly 2 into the controller. The controller controls the mechanical arm assembly 2 to move the corresponding coordinate value distance in the X direction, the Y direction, and the Z direction based on the input X-coordinate, the Y-coordinate, and the Z coordinate.

According to the present disclosure, the output results of the target recognition algorithm are sorted and calculated by inputting the ultrasonic image and the white light image into the target recognition algorithm at the same time to obtain the movement amount that the mechanical arm assembly 2 needs to move. According to the ultrasonic image and the white light image, the joint calibration can effectively improve the accuracy of the calibration and positioning of the mechanical arm assembly 2. In addition, after each movement of the mechanical arm assembly 2, the movement amount should be calculated and the movement threshold should be set. Through the determination method, it is determined whether the mechanical arm assembly 2 needs to move again, which can further improve the accuracy of calibration and positioning of the mechanical arm assembly 2, so that the quality of ultrasonic imaging is ensured. It can also be used in teaching.

It should be noted that the above content is only used to illustrate the present disclosure, rather than to limit the scope of protection of the present disclosure. Simple modifications or equivalent substitutions of the present disclosure by ordinary skilled in the art do not deviate from the essence and scope of the present disclosure.

What is claimed is:

1. An animal ultrasonic mechanical arm automatic calibration method, comprising following steps:
S1, building a target recognition model;
S2, placing a mechanical arm assembly in an initial state, fixing an animal to be detected on a fixed table, starting an ultrasound probe and a micro camera, taking a picture of the animal to be detected, obtaining an initial ultrasound image and an initial white light image, determining a type of a target organ, and marking the determined target organ on the initial white light image;
S3, inputting the initial ultrasound image, the marked initial white light image, and the determined target organ into the target recognition model constructed in the step S1 to obtain an output result, and obtaining an initial movement amount of the mechanical arm assembly according to the output result, the initial movement amount comprises an initial X-direction movement amount, an initial Y-direction movement amount, and an initial Z-direction movement amount; the step S3 comprises following steps:
S31, inputting the initial ultrasound image, the marked initial white light image, and the determined target organ into the target recognition model constructed in the step S1, and obtaining the output result, wherein the output result comprises a first initial pixel coordinate and a first initial confidence of the determined target organ in the initial ultrasound image, and a second initial pixel coordinate and a second initial confidence of the determined target organ in the marked initial white light image;
S32, converting the first initial pixel coordinate and the second initial pixel coordinate obtained in the step S31 into a first initial world coordinate and a second initial world coordinate;
S33, when the mechanical arm assembly is configured at an initial position, an initial world coordinate of the ultrasound probe is (X_{w1}, Y_{w1}, Z_{w1}), an initial world coordinate of the micro camera is (X_{w2}, Y_{w2}, Z_{w2}), a distance between the ultrasound probe and the micro camera in an X direction, a Y direction, and a Z direction in a world coordinate is calculated by following formulas:
$${X}_{Δ} = {X}_{w 1} - {X}_{w 2} ;$$
$${Y}_{Δ} = {Y}_{w 1} - {Y}_{w 2} ;$$
$${Z}_{Δ} = {Z}_{w 1} - {Z}_{w 2} ;$$
in the above formulas, X_{Δ} indicates the distance between the ultrasound probe and the micro camera in the X direction in the world coordinate, Y_{Δ} indicates the distance between the ultrasound probe and the micro camera in the Y direction in the world coordinate, Z_{Δ} indicates the distance between the ultrasound probe and the micro camera in the Z direction in the world coordinate; X_{w2} indicates a coordinate value of the initial world coordinate in the X direction of the micro camera, Y_{w2} indicates a coordinate value of the initial world coordinate in the Y direction of the micro camera, Z_{w2} indicates a coordinate value of the initial world coordinate in the Z direction of the micro camera;
S34, calculating an auxiliary world coordinate of the second initial world coordinate according to the distance between the ultrasound probe and the micro camera in the X direction, the Y direction, and the Z direction in the world coordinate by following formulas:
$${X}_{cs}^{′} = {X}_{cs 2} + {X}_{Δ} ;$$
$${Y}_{cs}^{′} = {Y}_{cs 2} + {Y}_{Δ} ;$$
$${Z}_{cs}^{′} = {Z}_{cs 2} + {Z}_{Δ} ;$$
in the above formulas, X_{cs2} indicates a coordinate value of the second initial world coordinate in the X direction, Y_{cs2} indicates a coordinate value of the second initial world coordinate in the Y-direction, Z_{cs2} indicates a coordinate value of the second initial world coordinate in the Z direction;
S35, calculating a total initial world coordinate of the determined target organ according to the auxiliary world coordinate and the first initial world coordinate; the total initial world coordinate is calculated by following formulas:
$${X}_{z} = {ω}_{1} \times {X}_{cs 1} + {ω}_{2} \times {X}_{cs}^{′} ;$$
$${Y}_{z} = {ω}_{1} \times {Y}_{cs 1} + {ω}_{2} \times {Y}_{cs}^{′} ;$$
$${Z}_{z} = {ω}_{1} \times {Z}_{cs 1} + {ω}_{2} \times {Z}_{cs}^{′} ;$$
$${ω}_{1} = \frac{{α}_{1}}{{α}_{1} + {α}_{2}} ;$$
$${ω}_{2} = \frac{{α}_{2}}{{α}_{1} + {α}_{2}} ;$$
in the above formulas, α₁ indicates the first initial confidence, α₂ indicates the second initial confidence, X_{z} indicates a coordinate value of the total initial world coordinate in the X direction, Y_{z} indicates a coordinate value of the total initial world coordinate in the Y direction, Z_{z} indicates a coordinate value of the total initial world coordinate in the Z direction; ω₁ indicates a first weight value, ω₂ indicates a second weight value; X_{cs1} indicates a coordinate value of the first initial world coordinate in the X direction, Y_{cs1} indicates a coordinate value of the first initial world coordinate in the Y direction, Z_{cs1} indicates a coordinate value of the first initial world coordinate in the Z direction; X_{cs}′ indicates a coordinate value of the auxiliary world coordinate in the X direction, Y_{cs}′ indicates a coordinate value of the auxiliary world coordinate in the Y direction, Z_{cs}′ indicates a coordinate value in the Z direction of the auxiliary world coordinate;
S36, calculating the initial X-direction movement amount, the initial Y-direction movement, and the initial Z-direction movement of the mechanical arm assembly according to the total initial world coordinate; according to following formulas:
$$Δ X = \vert {X}_{z} - {X}_{w 1} \vert ;$$
$$Δ Y = \vert {Y}_{z} - {Y}_{w 1} \vert ;$$
$$Δ Z = \vert {Z}_{z} - {Z}_{w 1} \vert ;$$
in the above formulas, ΔX indicates the initial X-direction movement amount, ΔY indicates the initial Y-direction movement amount, ΔZ indicates the initial Z-direction movement amount of the mechanical arm assembly; X_{w1} indicates a coordinate value of the initial world coordinate of the ultrasound probe in the X direction, Y_{w1} indicates a coordinate value of the initial world coordinate of the ultrasound probe in the Y direction, Z_{w1} indicates a coordinate value of the initial world coordinate of the ultrasound probe in the Z direction;
S4, controlling the mechanical arm assembly through a controller to move the mechanical arm assembly in the X direction of the world coordinate by the initial X-direction movement amount, in the Y direction of the world coordinate by the initial Y-direction movement amount, and in the Z direction of the world coordinate by the initial Z-direction movement amount, in a direction close to the animal to be detected, and a position of the mechanical arm assembly after movement is recorded as a first movement position;
S5, using the steps S2-S3 to obtain a re-movement amount of the mechanical arm assembly when the mechanical arm assembly is located at the first movement position, the re-movement amount comprises an X-direction re-movement amount, a Y-direction re-movement amount and a Z-direction re-movement amount, setting an X-direction movement threshold, a Y-direction movement threshold and a Z-direction movement threshold of the mechanical arm assembly, determining the X-direction re-movement amount, the Y-direction re-movement amount and the Z-direction re-movement amount with the X-direction movement threshold, the Y-direction movement threshold and the Z-direction movement threshold respectively, whether the mechanical arm assembly moves in the X direction, the Y direction and the Z direction, after the determination, when the mechanical arm assembly does not need to move in the X direction, the Y direction and the Z direction, completing the calibration of the mechanical arm assembly, otherwise, iterating the steps S4-S5.

2. The animal ultrasonic mechanical arm automatic calibration method according to claim 1, wherein determining whether the mechanical arm assembly moves in the X direction, the Y direction, and the Z direction in the step S5 is:
comparing the X-direction re-movement amount with the X-direction movement threshold of the mechanical arm assembly, when the X-direction re-movement amount is greater than the X-direction movement threshold of the mechanical arm assembly, the controller controls the mechanical arm assembly to move in the X-direction by the X-direction re-movement amount; when the X-direction re-movement amount is less than or equal to the X-direction movement threshold of the mechanical arm assembly, the controller does not control the mechanical arm assembly to move in the X-direction;
comparing the Y-direction re-movement amount with the Y-direction movement threshold of the mechanical arm assembly, when the Y-direction re-movement amount is greater than the Y-direction movement threshold of the mechanical arm assembly, the controller controls the mechanical arm assembly to move in the Y-direction by the Y-direction re-movement amount; when the Y-direction re-movement amount is less than or equal to the Y-direction movement threshold of the mechanical arm assembly, the controller does not control the mechanical arm assembly to move in the Y-direction;
comparing the Z-direction re-movement amount with the Z-direction movement threshold of the mechanical arm assembly, when the Z-direction re-movement amount is greater than the Z-direction movement threshold of the mechanical arm assembly, the controller controls the mechanical arm assembly to move in the Z-direction by the Z-direction re-movement amount; when the Z-direction re-movement amount is less than or equal to the Z-direction movement threshold of the mechanical arm assembly, the controller does not control the mechanical arm assembly to move in the Z-direction.

3. The animal ultrasonic mechanical arm automatic calibration method according to claim 1, wherein the step S1 comprises following steps:
S11, acquiring a plurality of historical ultrasound images and a plurality of historical white light images, each of the historical ultrasound images and each of the plurality of historical white light images comprise the animal to be detected;
S12, marking a plurality of the target organs on the animal to be detected in each of the plurality of historical white light images;
S13, training and obtaining the target recognition model using a YOLOv8 algorithm based on the plurality of historical ultrasound images obtained in the step S11 and the plurality of historical white light images processed in the step S12.

4. An animal ultrasonic mechanical arm automatic calibration system, executing the animal ultrasonic mechanical arm automatic calibration method according to claim 1, comprising abase, the mechanical arm assembly, the fixed table, a control device, the ultrasound probe and the micro camera, the mechanical arm assembly and the fixed table are connected to the base, an end of the mechanical arm assembly away from the base is connected to the ultrasound probe and the micro camera, relative positions of the ultrasound probe and the micro camera are fixed, the control device is electrically connected to the mechanical arm assembly, the ultrasound probe and the micro camera respectively, the ultrasound probe is configured to take ultrasonic images containing the animal to be detected, and the micro camera is configured to take the white light images containing the animal to be detected.
